(19) United States
(12) Patent Application Publication
(10) Pub. No.: US 2025/0176636 A1
(43) Pub. Date: Jun. 5, 2025

(54) Aerosol Generating Device

(71) Applicant: JT International SA, Geneva (CH)

(72) Inventors: Alec WRIGHT, Guildford (GB); Andrew Robert John ROGAN, Forres (GB)

(73) Assignee: JT International SA, Geneva (CH)

(21) Appl. No.: 18/700,141

(22) PCT Filed: Oct. 11, 2022
(86) PCT No.: PCT/EP2022/078314

§ 371 Date: Apr. 10, 2024

(30) Foreign Application Priority Data
Oct. 13, 2021 (EP) 21202521.7

(51) Int. Cl. A24F 40/51; A24F 40/10; A24F 40/42; A24F 40/485; A24F 40/53; A24F 40/57; A24F 40/65; G01N 27/04; G01N 27/22; G06K 7/10

(52) U.S. Cl. CPC A24F 40/51; A24F 40/10; A24F 40/42; A24F 40/485; A24F 40/53; A24F 40/57; A24F 40/65; G01N 27/048; G01N 27/223; G06K 7/10366

(57) ABSTRACT

An aerosol generating device configured to receive a consumable article containing aerosolisable liquid is disclosed. The aerosol generating device comprises a sensor arranged to penetrate the consumable article when the consumable article is received by the aerosol generating device, wherein the sensor is configured to sense the water content of the aerosolisable liquid contained within the consumable article; a short-range wireless reader configured to read data indicative of an aspect of a composition of the aerosolisable liquid from a short-range wireless transponder in the consumable article; and control circuitry configured to control a supply of power to the consumable article to generate an aerosol for inhalation by a user, wherein the supply of power is controlled based on the water content and the aspect of the composition of the aerosolisable liquid.

### FIELD OF INVENTION

The present invention relates to an aerosol generating device and a consumable article for an aerosol generating device.

### BACKGROUND

Aerosol generating devices such as inhalers or e-cigarettes have gained popularity in recent years. Often, aerosol generating devices are configured to receive a disposable cartridge comprising a heater and a container of aerosolisable liquid including an active ingredient, such as nicotine. In use, power is supplied from the aerosol generating device to the heater in the cartridge, thereby generating heat and producing an aerosol for inhalation by a user.

One problem with current aerosol generating devices that utilise such cartridges is that it is difficult to provide a consistent and controlled dose of active ingredient to the user. Regulations surrounding aerosol generating devices are becoming increasingly strict around the globe, and aerosol generating devices are now often being viewed as medical products that deliver nicotine. Therefore, reliably controlling the amount of active ingredient delivered to the user is particularly desirable.

An object of the present invention is to address this problem.

### SUMMARY OF INVENTION

According to a first aspect of the invention, there is provided an aerosol generating device configured to receive a consumable article containing aerosolisable liquid, wherein the aerosol generating device comprises: a sensor arranged to penetrate the consumable article when the consumable article is received by the aerosol generating device, wherein the sensor is configured to sense the water content of the aerosolisable liquid contained within the consumable article; a short-range wireless reader configured to read data indicative of an aspect of a composition of the aerosolisable liquid from a short-range wireless transponder in the consumable article; and control circuitry configured to control a supply of power to the consumable article to generate an aerosol for inhalation by a user, wherein the supply of power is controlled based on the water content and the aspect of the composition of the aerosolisable liquid.

In this way, a controlled dose of active ingredient in the aerosol may be delivered to the user over the entire lifetime of the consumable article.

The amount of aerosol that is generated is dependent on the power supplied to the aerosolisable liquid. In addition, the composition of aerosolisable liquid affects the temperature and power required to produce an aerosol, and therefore the composition of the resulting aerosol varies depending on the applied power. In particular, the water content and the concentration of other components of the aerosolisable liquid such as propylene glycol, glycerin, active ingredient, and flavourings can be correlated to the amount of active ingredient delivered in an aerosol at a given power. It has also been found that the water content of aerosolisable liquid varies over time due to the ingress of water from the atmosphere to the container of aerosolisable liquid. As a result, in conventional aerosol generating devices which are configured to always apply the same amount of power to the aerosolisable liquid within a consumable article, the dose of active ingredient provided to the user will vary over time as the water content in the aerosolisable liquid increases.

Accordingly, by providing a sensor in the aerosol generating device which is configured to penetrate the consumable article to detect the water content of the aerosolisable liquid, and providing a short-range wireless reader configured to read data indicative of an aspect of the composition of aerosolisable liquid from a short-range wireless transponder in the consumable article, the power supplied to the consumable can be controlled dependent on these values, thereby allowing production of an aerosol with a controlled amount of active ingredient.

Preferably, the supply of power is controlled such that the aerosol generated by the consumable article provides a predetermined dose of active ingredient to the user.

Preferably, controlling the supply of power comprises controlling the duration and magnitude of the supply of power.

Preferably, the aerosol generating device further comprises a battery configured to supply power to the consumable article when the consumable article is received by the aerosol generating device.

Preferably, the short-range wireless reader comprises a radio-frequency identification, RFID, reader. In this way, the data indicative of the aspect of the composition of aerosolisable liquid may be reliably and instantaneously read from a corresponding RFID transponder in the consumable article. RFID technology also does not require a direct line of sight such that the RFID reader may be internally disposed within the aerosol generating device. Alternative short-range wireless readers may operate using Bluetooth, infrared, or near-field-communication (NFC).

In one embodiment, the sensor is configured to sense the water content of the aerosolisable liquid by measuring the capacitance of the aerosolisable liquid. In another embodiment, the sensor is configured to sense the water content of the aerosolisable liquid by measuring the conductivity of the aerosolisable liquid. In this way, the water content is measured based on the change in physical properties of the aerosolisable liquid, thereby providing an efficient and reliable method for determining the water content.

For example, the sensor may comprise two electrodes separated by a gap, and wherein the sensor is configured to measure the conductivity of the aerosolisable liquid by: applying a voltage across the gap between the two electrodes; measuring the resulting current; and calculating the conductivity of the aerosolisable liquid within the gap based on the measured current and the distance between the electrodes.

Preferably, the data indicative of the aspect of the composition of the aerosolisable liquid comprises data indicative of one or more of: a concentration of active ingredient; a concentration of propylene glycol; a concentration of glycerin; and a concentration of flavourings.

Preferably, the concentration of active ingredient is a concentration of nicotine.

According to a second aspect of the invention, there is provided a consumable article configured to be received by an aerosol generating device, comprising: a container for storing aerosolisable liquid, wherein the container comprises an inlet configured to be penetrated by a sensor of the aerosol generating device when the consumable article is received by the aerosol generating device; a heating element configured to receive power from the aerosol generating device and to supply heat to the aerosolisable liquid to generate an aerosol for inhalation by a user; and a short-range wireless transponder configured to store data indicative of an aspect of the composition of the aerosolisable liquid.

Preferably, the inlet comprises a valve configured to prevent leakage of the aerosolisable liquid from the container. In this way, the sensor of the aerosol generating device may be repeatedly inserted and withdrawn from the container, via the inlet, without reducing the amount of aerosolisable liquid in the container.

Preferably, the short-range wireless transponder comprise a radio-frequency identification, RFID, transponder. In this way, the data indicative of the aspect of the composition of aerosolisable liquid may be reliably and instantaneously read by a corresponding RFID reader in the aerosol generating device. RFID technology also does not require a direct line of sight such that the RFID transponder may be internally disposed within the consumable article. Alternative short-range wireless transponders may operate using Bluetooth, infrared, or near-field-communication (NFC).

According to a third aspect of the invention, there is provided an aerosol generating system comprising: an aerosol generating device of the first aspect; and a consumable article of the second aspect.

According to a fourth aspect of the invention, there is provided a method of operating an aerosol generating device, comprising: receiving a consumable article comprising a container storing aerosolisable liquid, wherein receiving the consumable comprises: penetrating, with a sensor of the aerosol generating device, an inlet of the container of the consumable article; sensing, with the sensor of the aerosol generating device, the water content of the aerosolisable liquid contained within the consumable article; and reading, with a short-range wireless reader of the aerosol generating device, data indicative of an aspect of a composition of the aerosolisable liquid from a short-range wireless transponder in the consumable article; controlling, with control circuitry of the aerosol generating device, a supply of power to the consumable article to generate an aerosol for inhalation by a user, wherein the supply of power is controlled based on the water content and the aspect of the composition of the aerosolisable liquid.

### BRIEF DESCRIPTION OF DRAWINGS

Embodiments of the invention are now described, by way of example, with reference to the drawings, in which:

FIG. 1A shows a cross-sectional view of an aerosol generating system comprising an aerosol generating device and a consumable article, wherein the consumable article is not coupled to the aerosol generating device.

FIG. 1B shows a cross-sectional view of the aerosol generating system of FIG. 1A, wherein the consumable article is coupled to the aerosol generating device.

### DETAILED DESCRIPTION

As described herein, a vapour is generally understood to refer to a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

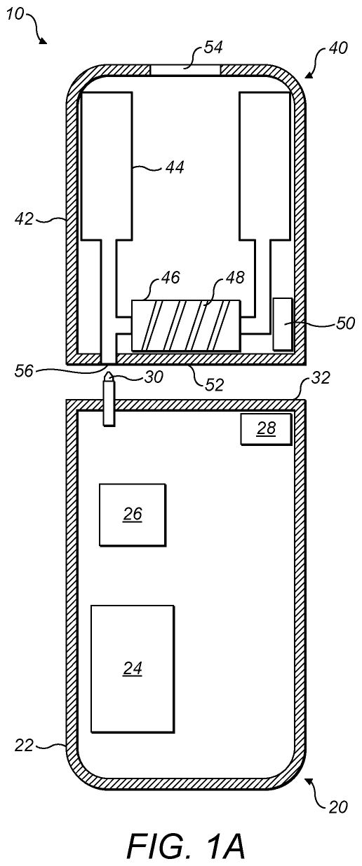

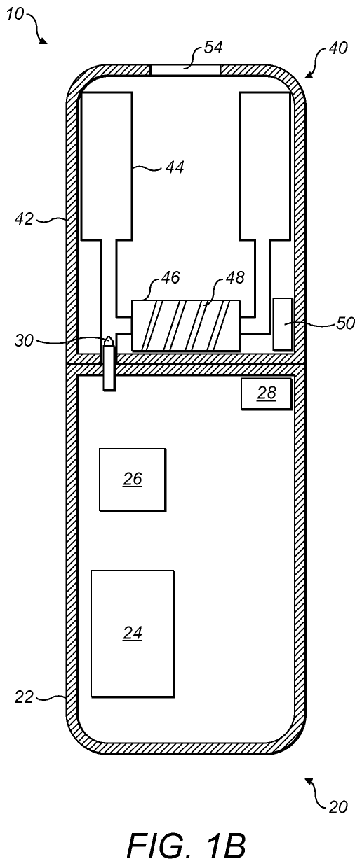

FIGS. 1A and 1B illustrate cross-sectional views of an aerosol generating system 10 comprising an aerosol generating device 20 and a consumable article 40. For example, the aerosol generating device 20 may be an electronic cigarette or inhaler.

In FIG. 1A, the consumable article 40 is not attached to the aerosol generating device 20, corresponding to a first condition of the aerosol generating system 10. In FIG. 1B, the consumable article 40 is attached to the aerosol generating device 20, corresponding to a second condition of the aerosol generating system 40. A user may manually couple and decouple the consumable article 40 from the aerosol generating device 20, i.e. alternate between the first condition and the second condition of the aerosol generating system 10. The skilled person will appreciate that the consumable article 40 is an exchangeable (replaceable) component of the aerosol generating system 10.

The aerosol generating device 20 comprises a body portion 22 housing various components of the aerosol generating device 20. In the depicted embodiment, the body portion 22 is elongate, but the skilled person will appreciate that the body portion 22 may be formed in any shape that is sized to fit the components described in the various embodiments set out herein and to be comfortably held by a user unaided, in a single hand. For example, the body portion 22 may be cuboidal or cylindrical. The aerosol generating device 20 comprises a connecting end 32 which is configured to receive, i.e. connect to, the consumable article 40.

The aerosol generating device 20 comprises a battery 24, control circuitry 26, and a short-range wireless reader 28 positioned in the body portion 22. The aerosol generating device 20 further comprises a sensor 30 extending from the body portion 22. Specifically, the sensor 30 is disposed adjacent the connecting end 32 of the body portion 22.

The control circuitry 26 is provided in electronic communication (e.g. wired or wireless) with the battery 24, the short-range wireless reader 28, and the sensor 30. The control circuitry 26 may comprise at least one processor and a memory (not shown), e.g. the control circuitry may comprise a microcontroller unit (MCU). The memory may store a computer program embodied in a non-transitory computer readable storage medium having computer-executable instructions for performing the various functions of the control circuitry 26. As will be appreciated by a person skilled in the art, a data storage unit (not shown) may also be provided in electronic communication with the control circuitry, and may be located within the aerosol generating device 20 or may be located remotely, such as in the case of a remote server. The data storage unit may contain data such as look-up tables and calibration data.

The control circuitry 26 is responsible for controlling the operation of the aerosol generating device 20 (and aerosol generating system 10 as a whole). In particular, the control circuitry 26 is configured to control a supply of electrical power from the battery 24 to the consumable article 40, as will be discussed in further detail below.

The battery 22 may be a lithium-ion battery, a nickel cadmium battery, a nickel-metal hydride battery, a lead-acid battery, or any other type of rechargeable battery.

The short-range wireless reader 28 is disposed within the body portion 22 and is located adjacent or towards the connecting end 32 of the aerosol generating device 20. The short-range wireless reader 28 preferably comprises a radio-frequency identification (RFID) reader. However, the skilled person will appreciate that alternative short-range wireless readers may be used such as a short-range wireless reader that operates via Bluetooth, infrared, or near-field-communication (NFC).

The sensor 30 (also referred to as a moisture sensor or probe) is configured to measure the water content of aerosolisable liquid. As illustrated in FIG. 1A, a first portion of the sensor 30 is located within the body portion 22 and a second portion of the sensor 30 extends from the body portion 22. Specifically, the sensor 30 extends away from the connecting end 32 of the aerosol generating device 20. The sensor 30 is substantially cylindrical and comprises a sensing tip which is at the end of the second portion of the sensor 30.

The sensor 30 operates by detecting the physical properties of aerosolisable liquid which vary in accordance with the amount (or proportion) of water present in the aerosolisable liquid. In one embodiment, the sensor 30 may be configured to measure the capacitance of the aerosolisable liquid which allows calculation of the amount (or proportion) of water present. In particular, when the amount of water changes in the aerosolisable liquid, e.g. a dielectric liquid such as a mixture including propylene glycol and vegetable glycerine (PG/VG), the sensor 30 will measure a change in capacitance due to the change in dielectric permittivity that can be directly correlated with a change in water content. Look-up tables or calibration data, such as those stored in the data storage unit, may be used to calculate the water content based on the capacitance.

In another embodiment, the sensor 30 may be configured to measure the conductivity of the aerosolisable liquid which allows calculation of the amount (or proportion) of water present in the aerosolisable liquid. Water will dissociate into ions within the aerosolisable liquid so that, as the water content of the aerosolisable liquid increases, the conductivity of the aerosolisable liquid also increases. Therefore, as the conductivity of the aerosolisable liquid can be directly correlated to the water content of the aerosolisable liquid, the water content of the aerosolisable liquid can be calculated based on the measured conductivity, e.g. using look-tables or calibration data.

In particular, in order to measure the conductivity of the aerosolisable liquid, the sensor 30 may comprise two electrodes separated by a known distance. When the sensor 30 is inserted into the consumable article 40, aerosolisable liquid will be present in the gap between the two electrodes. A voltage is then applied across the two electrodes (e.g using the control circuitry 26) and the resulting current is measured. Using Ohm's law, the resistance can be calculated. The resistivity (and thus conductivity) of the aerosolisable liquid can then be calculated based on the measured resistance and the distance between the two electrodes (e.g. using Pouillet's law). Preferably, the distance between the electrodes should be as large as possible in order to maximise the accuracy of the conductivity calculation.

The consumable article 40 comprises a housing 42 in which various components of the consumable article 40 are located. The consumable article 40 may also be referred to as a capsule, cartridge or pod.

The consumable article 40 comprises a container 44 for storing aerosolisable liquid, a wicking element 46, a heater 48, and a short-range wireless transponder 50, each located in the housing 42. The consumable article 40 comprises a connecting end 52 which is configured to be received by, i.e. connect to, the aerosol generating device 20. Opposite the connecting end 52 is a mouth end 54 which is configured to be received in the mouth of a user. In use, aerosol is delivered to the user via the mouth end 54.

In the depicted embodiment, the housing 22 is substantially cuboidal, but the skilled person will appreciate that the housing 22 may be formed in any shape that is suitable to be received in the mouth of a user and is sized to fit the components described in the various embodiments set out herein.

The container 44 is configured to store aerosolisable liquid and arranged to supply the aerosolisable liquid to the wicking element 46. The container 44 comprises an inlet 56 configured to be penetrated by the sensor 30 of the aerosol generating device 20 when the consumable article 40 is received by the aerosol generating device 20. The inlet 56 is located adjacent the connecting end 52 at a position that aligns with the sensor 30 of the aerosol generating device 20 when coupled, i.e. when in the second position. The inlet 56 further comprises a valve such that aerosolisable liquid is prevented from leaking from the container 44 via the inlet 56 whilst allowing the sensor 30 to be inserted and removed from container 44 during use. For example, the valve may be a duck bill valve, ball plunge valve or any other suitable valve. Additionally, an O-ring may be disposed around the inlet 56 or around the sensor 30 to further ensure that aerosolisable liquid does not leak from the container 44.

In the embodiment illustrated in FIGS. 1A and 1B the container 44 is annular, but the skilled person will appreciate that the shape and arrangement of the container 44 may vary.

The aerosolisable liquid stored within the container 44 may comprise propylene glycol or glycerin (e.g. vegetable glycerine) or a mixture thereof, which is able to produce a visible aerosol. The aerosolisable liquid further comprises an active ingredient, such as nicotine, and may further comprise other substances such as flavourings.

The wicking element 46 is arranged to receive aerosolisable liquid from the container 44. The heater 48 is configured to heat the aerosolisable liquid received by the wicking element 46, thereby generating an aerosol which may be supplied to the user via the mouth end 54. The heater 48 is a resistive heating element formed as a coil of wire that is wrapped around the wicking element 46. An electrical supply path (not shown) is formed between the heater 48 and the battery 24 when the consumable article 40 is received by the aerosol generating device 20. In use, the heater 48 receives electrical power from the aerosol generating device 20, and in particular the battery 24 of the aerosol generating device, thereby generating heat by Joule heating.

The heating element may comprise metal (e.g. Nichrome, Kanthal, or Cupronickel), ceramic or any other suitable resistive heating material. As will be appreciated by the skilled person, the heater 48 is not limited to a wire heating element, and the type and arrangement of heater 48 may vary.

The short-range wireless transponder 50 is disposed within the housing 42 and is located adjacent or towards the connecting end 52 of the consumable article 40. The short-range wireless transponder 50 preferably comprises a radio-frequency identification (RFID) transponder. However, the skilled person will appreciate that alternative short-range wireless transponder may be used such as a short-range wireless transponder that operates via Bluetooth, infrared, or near-field-communication (NFC).

The short-range wireless transponder 50 is configured to store data indicative of (an aspect of) a composition of aerosolisable liquid, corresponding to the composition of the aerosolisable liquid stored in the container 44. In particular, the data indicative of the composition of aerosolisable liquid may comprise data indicative of the concentration, amount and/or type of components of the aerosolisable liquid, such as a concentration, amount and/or type of active ingredient, a concentration, amount and/or type of propylene glycol, a concentration, amount and/or type of glycerin, and a concentration, amount and/or type of flavourings. That is, the composition of aerosolisable liquid corresponds to the composition of the aerosolisable liquid upon initial storage within the container 44, i.e. prior to the ingress of water. Specifically, the data indicative of the composition of aerosolisable liquid comprises data indicative of the concentration or amount of components other than water in the aerosolisable liquid. The short-range wireless reader 28 in the aerosol generating device 20 is configured to read the data indicative of the composition of aerosolisable liquid from the short-range wireless transponder 50 in the consumable article 40 when the consumable article 40 is coupled to the aerosol generating device 20.

In use, the user may couple the consumable article 40 to the aerosol generating device 20. In particular, the user connects the connecting end 32 of the aerosol generating device 20 to the connecting end 52 of the consumable article 40 such that the sensor 30 is inserted into the container 44 via the inlet 56. When inserted, the sensor 30 measures the water content of the aerosolisable liquid in the container 44. The short-range wireless reader 28 reads the data indicative of the composition of the aerosolisable liquid from the short-range wireless transponder 50. As the short-range wireless transponder 50 is located adjacent to the short-range wireless reader 28, the data indicative of the composition of aerosolisable liquid can be reliably read.

The control circuitry 26 receives data indicative of the water content and the composition of aerosolisable liquid from the sensor 30 and the short-range wireless reader 28 respectively. Upon inhalation by the user at the mouth end 54, or another action performed by the user indicating that aerosol generation is required (e.g. actuation of a button), electrical power is supplied from the battery 24 of the aerosol generating device 20 to the heater 46 of the consumable article 20. This results in the generation of an aerosol from the aerosolisable liquid received by the wicking element 46.

The power supplied from the aerosol generating device 20 to the consumable article 40 is controlled by the control circuitry 26 dependent upon the water content and the composition of aerosolisable liquid. As the amount of active ingredient included in a generated aerosol can be correlated to the water content of the aerosolisable liquid, the composition of other components in the aerosolisable liquid, and the power supplied to the aerosolisable liquid, an aerosol comprising a controlled dose of active ingredient may be supplied to user.

Specifically, the control circuitry 26 is configured to control the magnitude and duration of the power supplied to the consumable article 40 in accordance with the water content and composition of the aerosolisable liquid. In some examples, the control circuitry 26 may compare the water content and the composition of aerosolisable liquid to data stored in look-up tables and/or calibration data (e.g. in the data storage unit) to determine the magnitude and duration of power required to produce a pre-determined dose of the active ingredient. The look-up tables may contain data relating the energy input (i.e. magnitude and duration of power input) required to produce an aerosol comprising a pre-determined dose of active ingredient to the water content and the composition of the aerosolisable liquid.

The pre-determined dose of active ingredient to be provided in the aerosol may be set by the manufacturer of the aerosol generating device 20. Additionally or alternatively, the user of the aerosol generating device 20 may select or adjust the dose of active ingredient to be delivered in the aerosol. For example, the user may adjust the dose of active ingredient using one or more buttons or sliders on the aerosol generating device 20, or using software installed on an electronic device that is in electronic communication with the aerosol generating device 20.

1. An aerosol generating device configured to receive a consumable article containing aerosolisable liquid, wherein the aerosol generating device comprises:
a sensor arranged to penetrate the consumable article when the consumable article is received by the aerosol generating device, wherein the sensor is configured to sense a water content of the aerosolisable liquid contained within the consumable article;
a short-range wireless reader configured to read data indicative of an aspect of a composition of the aerosolisable liquid from a short-range wireless transponder in the consumable article; and
control circuitry configured to control a supply of power to the consumable article to generate an aerosol for inhalation by a user, wherein the supply of power is controlled based on the water content and the aspect of the composition of the aerosolisable liquid.

2. The aerosol generating device of claim 1, wherein the supply of power is controlled such that the aerosol generated by the consumable article provides a predetermined dose of active ingredient to the user.

3. The aerosol generating device of claim 1, wherein controlling the supply of power comprises controlling a duration and a magnitude of the supply of power.

4. The aerosol generating device of claim 1, further comprising a battery configured to supply power to the consumable article when the consumable article is received by the aerosol generating device.

5. The aerosol generating device of claim 1, wherein the short-range wireless reader comprises a radio-frequency identification, RFID, reader.

6. The aerosol generating device of claim 1, wherein the sensor is configured to sense the water content of the aerosolisable liquid by measuring a capacitance of the aerosolisable liquid.

7. The aerosol generating device of claim 1, wherein the sensor is configured to sense the water content of the aerosolisable liquid by measuring a conductivity of the aerosolisable liquid.

8. The aerosol generating device of claim 1, wherein the data indicative of the aspect of the composition of the aerosolisable liquid comprises data indicative of one or more of: a concentration of active ingredient; a concentration of propylene glycol; a concentration of glycerin; or a concentration of flavourings.

9. The aerosol generating device of claim 8, wherein the concentration of active ingredient is a concentration of nicotine.

10. A consumable article configured to be received by an aerosol generating device, comprising:
a container for storing aerosolisable liquid, wherein the container comprises an inlet configured to be penetrated by a sensor of the aerosol generating device when the consumable article is received by the aerosol generating device;
a heating element configured to receive power from the aerosol generating device and to supply heat to the aerosolisable liquid to generate an aerosol for inhalation by a user; and
a short-range wireless transponder configured to store data indicative of an aspect of a composition of the aerosolisable liquid.

11. The consumable article of claim 10, wherein the inlet comprises a valve configured to prevent leakage of the aerosolisable liquid from the container.

12. The consumable article of claim 10, wherein the short-range wireless transponder comprises a radio-frequency identification, RFID, transponder.

13. (canceled)

14. A method of operating an aerosol generating device, comprising:
receiving a consumable article comprising a container storing aerosolisable liquid, wherein receiving the consumable article comprises: penetrating, with a sensor of the aerosol generating device, an inlet of the container of the consumable article;
sensing, with the sensor of the aerosol generating device, a water content of the aerosolisable liquid contained within the consumable article;
reading, with a short-range wireless reader of the aerosol generating device, data indicative of an aspect of a composition of the aerosolisable liquid from a short-range wireless transponder in the consumable article; and
controlling, with control circuitry of the aerosol generating device, a supply of power to the consumable article to generate an aerosol for inhalation by a user, wherein the supply of power is controlled based on the water content and the aspect of the composition of the aerosolisable liquid.
